(19) United States
(12) Patent Application Publication
(10) Pub. No.: US 2011/0308049 A1
(43) Pub. Date: Dec. 22, 2011

(54) Wire fastening band

(76) Inventor: Wen-Wei Sun, Jhonghe City (TW)

(21) Appl. No.: 12/076,444

(22) Filed: Mar. 18, 2008

(51) Int. Cl. F16G 11/02; H01F 7/02; A44B 18/00

(52) U.S. Cl. 24/306; 24/115 A; 24/303

(57) ABSTRACT

A wire fastening band is made by a soft material and can be sheathed on a wire by using a commissure formed on a sleeve. The sleeve is extended with a wrapping member to fix and fasten the collected wire. The sleeve on the wire is also formed with a first fastening member, a second fastening member, and a first corresponding fastening member. The first fastening member is fastened with the first corresponding fastening member to fix the sheathed wire, and then the second fastening member is fastened with a second corresponding fastening member on the wrapping member to quickly and conveniently fix and fasten the collected wire.

### BACKGROUND OF THE INVENTION

a) Field of the Invention

The present invention relates to a wire fastening band used to fix a wire that has been wound, and more particularly to a wire fastening band which can be sheathed on the wire quickly and conveniently, and can fix the wire that has been wound, such that the wire will not be dropped out or intertwined.

b) Description of the Prior Art

It is known that some of daily articles in an everyday life are usually added with some wires; for example, an ordinary household electrical appliance will be equipped with an electric cable, and an earphone will have a wire. In using the electrical appliances, the wires which are exposed out of the appliances will be intertwined, easily resulting in a danger of being tripped when a user passes by, and being not pretty either. In addition, when the appliances are collected after being used, as the user seldom knows how to collect the wires, the wires are always wound on articles, tied up casually, or left alone without taking care of. Therefore, if the appliances are to be used next time, in addition to that time must be wasted to unwind the intertwined wires, when the wires are intertwined, it is easy to result in fracture to inner wirings of the wires due to excessive distortion, thereby easily causing damage to the articles. Accordingly, improvement to the prior art is required.

### SUMMARY OF THE INVENTION

The primary object of the present invention is to provide a wire fastening band which can be sheathed on the wire quickly and conveniently, and can wrap and fix the wound wire, such that the wire will not be dropped out or intertwined.

Accordingly, a wire fastening band of the present invention includes a first fastening member, a second fastening member, a first corresponding fastening member, a second corresponding fastening member, a wrapping member, and a sleeve. When a wire is sheathed into the sleeve through a commissure formed on the sleeve, the wire fastening band can freely slide on the wire using features that the wire fastening band is provided with a different material and a different friction force than the wire. In addition, by the formation of the commissure, the wire fastening band can be easily sheathed on the wire. On the other hand, an upper end of the sleeve are formed with the first fastening member and the second fastening member, and a lower end of the sleeve is extendedly formed with the wrapping member, an end of which are formed with the first corresponding fastening member and the second corresponding fastening member. When the first corresponding fastening member is fastened with the first fastening member, the sleeve will wrap and fix the wire; whereas, when the second corresponding fastening member is fastened with the second fastening member, the wrapping member will wrap the wire, such that the wire fastening band can be sheathed on the wire quickly and conveniently, and the entire wound wire can be wrapped without being dropped out or intertwined.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view the present invention.

FIG. 2 shows a schematic view of an embodiment of the present invention.

FIG. 3 shows a schematic view of a second embodiment of the present invention.

FIG. 4 shows a schematic view of a third embodiment of the present invention.

FIG. 5 shows a schematic view of a fourth embodiment of the present invention.

FIG. 6 shows a schematic view of a fifth embodiment of the present invention.

### DETAILED DESCRIPTION OF THE PREFERRED EMBODIMENTS

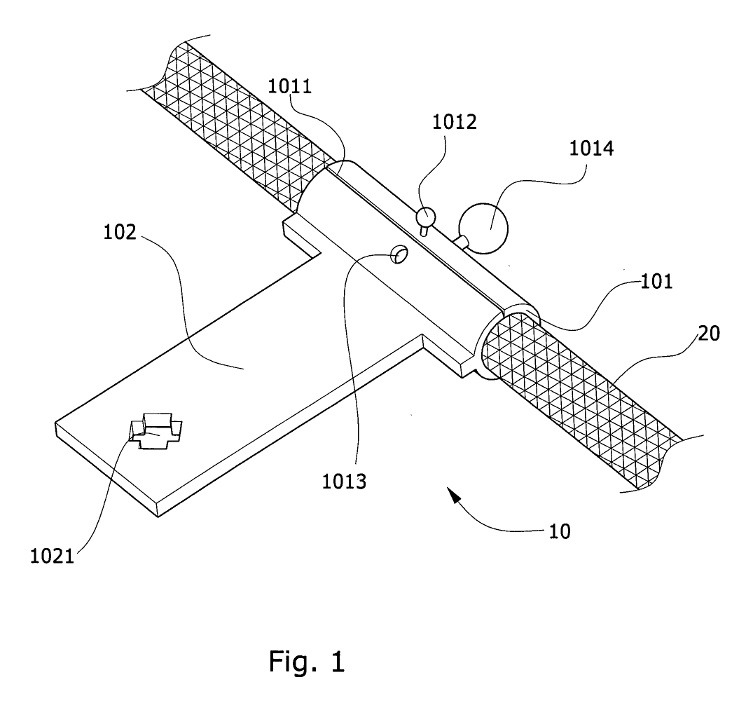

Referring to FIG. 1, it shows a perspective view of the present invention, wherein a wire fastening band 10 is made by a soft material, such as formed by a rubber extrusion. The wire fastening band 10 is formed with a sleeve 101, an outer circumferential surface of which is formed with a commissure 1011. By the formation of the commissure 1011, the sleeve 101 can be sheathed on a wire 20 directly. After sheathing, the wire fastening band 10 is hung on the wire 20 normally, by a function of the sleeve 101. In addition, above the commissure 1011 of the sleeve 101 are formed with a first fastening member 1012 and a second fastening member 1014; whereas, below the commissure 1011 is formed with a first corresponding fastening member 1013 which is formed as a through-hole. As shown in the drawing, the first fastening member 1012 and the second fastening member 1014 are formed as protruded points, and the outer circumferential surface of the sleeve 101 is further extendedly formed with a plate or a strip of wrapping member 102, with a plane close to a bottom of the wrapping member 102 being formed with a second corresponding fastening member 1021 which is formed as a through-hole. Referring to FIG. 1 again, when the first fastening member 1012 is fastened with the first corresponding fastening member 1013, and the second fastening member 1014 is fastened with the second corresponding fastening member 1021, effects of fastening and preventing the wire 20 from being dropped out are achieved by using flexibility of the material itself.

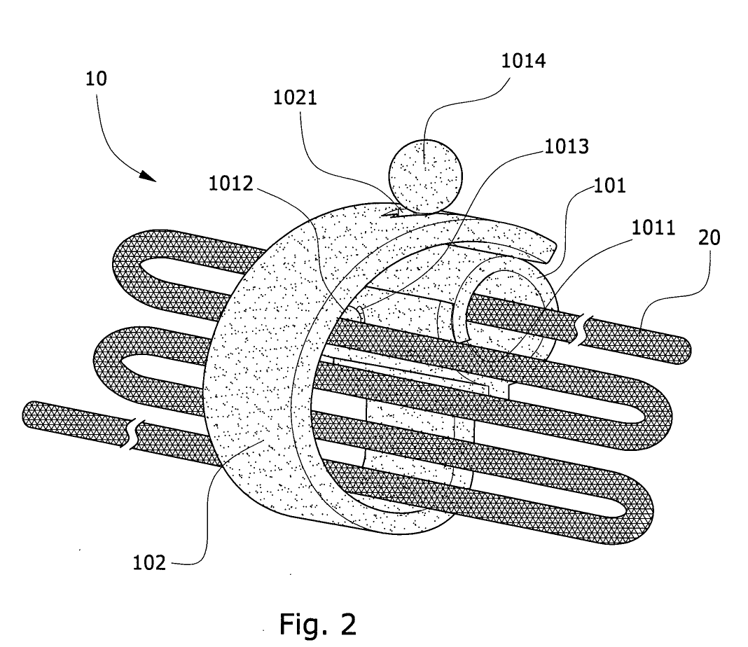

Referring to FIG. 2, it shows a schematic view of an embodiment of the present invention. As the wire fastening band 10 is made by a soft material, the commissure 1011 can be properly opened or closed flexibly after being exerted with force. By using the feature that the commissure 1011 can be opened or closed properly, the sleeve 101 can be quickly sheathed on the wire 20 when the commissure 1011 is opened upon being exerted with force, and then the first fastening member 1012 is transfixed through the first corresponding fastening member 1013, allowing the sleeve 101 to be hung on the wire 20 normally. A user can also assemble the wire fastening band 10 on any wire according to a practical need, fold up the wire 20 which is exposed out of the wire fastening band 10, put the folded wire 20 on a plane of the wrapping member 102 of the wire fastening band 10, and then wind the wrapping member 102, allowing the second fastening member 1014 to be transfixed through the second corresponding fastening member 1021 of the wrapping member 102, thereby accomplishing the wire fastening operation. On the other hand, as the first corresponding fastening member 1013 on the outer circumferential surface of the sleeve 101 achieves a fixing function by being fastened with the first fastening member 1012, the sleeve 101 can enclose the wire 20. In addition, as the second corresponding fastening member 1021 which is close to the bottom of the wrapping member 102 has achieved a fixing function by being fastened with the second fastening member 1014, the wire 20 can be neatly wrapped and confined in the wrapping member 102. In other words, the functions of sheathing the wire fastening band 10 on the wire 20 and fastening the wire 20 can be quickly achieved. Therefore, disorder of the wire can be effectively solved, and by using the features that the material of wire fastening band is flexible and the sleeve is formed with the commissure, wire fastening and loosening can all be quickly accomplished, thereby meeting the practical requirement.

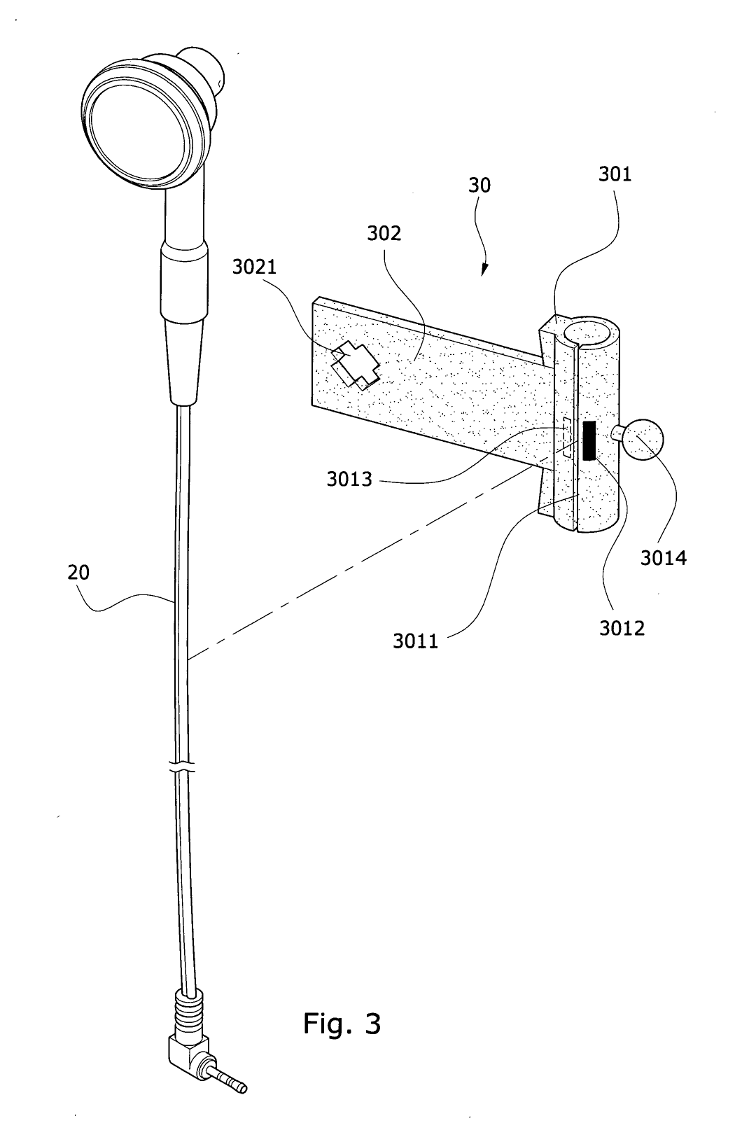

Referring to FIG. 3, it shows a schematic view of a second embodiment of the present invention, wherein a wire fastening band 30 is integrally formed by a soft rubber, and includes a sleeve 301 after being formed. A circumferential surface of the sleeve 301 is formed with a commissure 3011, and an outer circumferential surface of the sleeve 301 is extendedly formed with a wrapping member 302. As shown in the drawing again, above the sleeve 301 is attached with a first Velcro tape 3012 (or a magnet), and at a corresponding position in an interior side of the sleeve 301 is also attached with a first corresponding Velcro tape 3013 (or a magnet). At a position close to a top of the first Velcro tape 3012 is formed with a first fastening member 3014, and a corresponding position on a plane of the wrapping member 302 is formed with a first corresponding fastening member 3021. Upon implementing, the sleeve 301 is first sheathed on a wire 20 (such as an earphone wire or a power cable) with the commissure 3011, and then the first Velcro tape 3012 is affixed with the first corresponding Velcro tape 3013 to fix the wire fastening band 30 on the wire 20. Next, the wire 20 which is exposed out of the sleeve 301 is folded up, and emplaced flat on the plane of the wrapping member 302; then, the wrapping member 302 is rolled up to fasten the first fastening member 3014 with the first corresponding fastening member 3021, thereby accomplishing the wire fastening operation quickly. In loosening the wire, on the other hand, it can be accomplished by only separating the first fastening member 3014 with the first corresponding fastening member 3021.

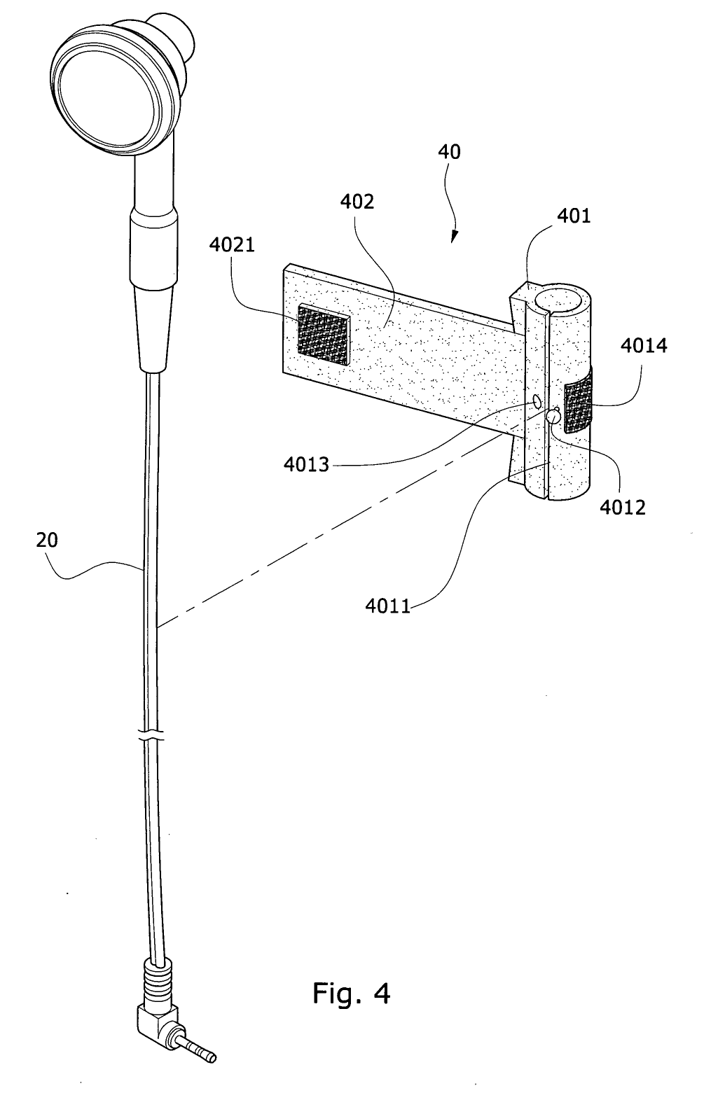

Referring to FIG. 4, it shows a schematic view of a third embodiment of the present invention, wherein a wire fastening band 40 is integrally formed by a soft rubber and includes a sleeve 401 after being formed. A circumferential surface of the sleeve 401 is formed with a commissure 4011, and an outer circumferential surface of the sleeve 401 is extendedly formed with a wrapping member 402. As shown in the drawing again, above the sleeve 401 is formed with a first fastening member 4012, at a corresponding position in an interior side of the sleeve 401 is attached with a first corresponding fastening member 4013, at a position close to a top of the first fastening member 4012 is attached with a first Velcro tape 4014 (or a magnet), and at a corresponding position on a plane of the wrapping member 402 is also formed with a first corresponding Velcro tape 4021 (or a magnet). Upon implementing, the sleeve 401 is first sheathed on a wire 20 (such as an earphone wire or a power cable) with the commissure 4011, and then the first fastening member 4012 is fastened with the first corresponding fastening member 4013 to fix the wire fastening band 40 on the wire 20. Next, the wire 20 which is exposed out of the sleeve 401 is folded up, and emplaced flat on the plane of the wrapping member 402; then, the wrapping member 402 is rolled up to affix the first Velcro tape 4014 with the first corresponding Velcro tape 4021, thereby accomplishing the wire fastening operation quickly. In loosening the wire, on the other hand, it can be accomplished by only separating the first Velcro tape 4014 with the first corresponding Velcro tape 4021.

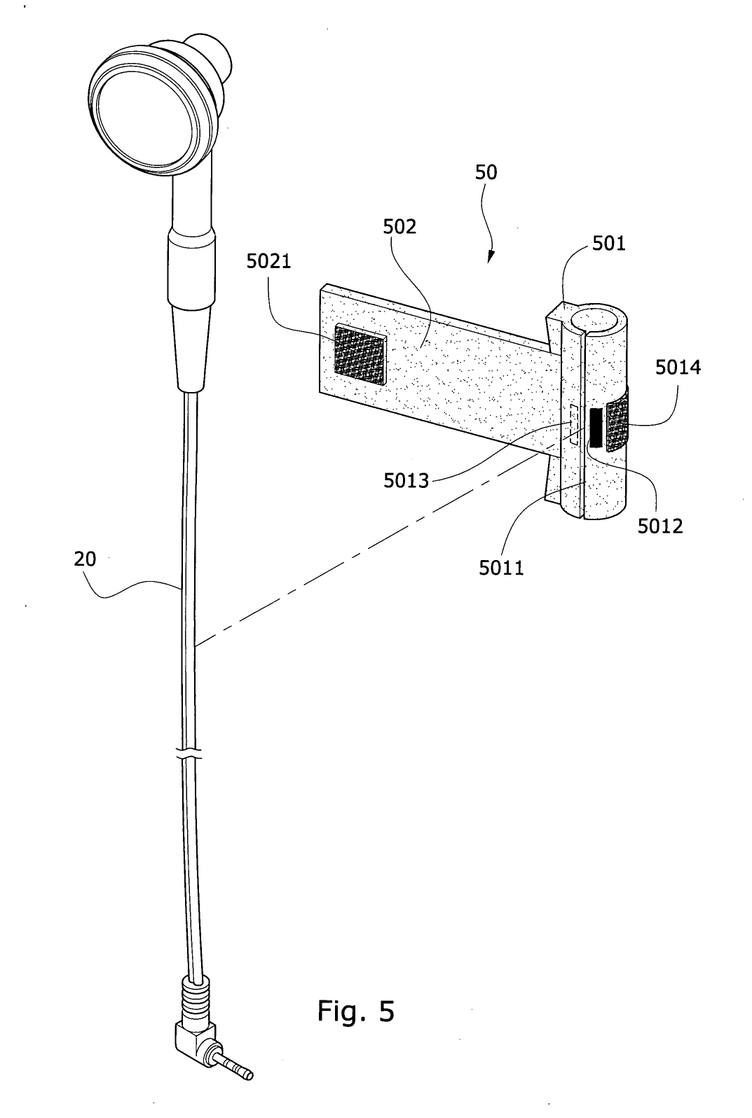

Referring to FIG. 5, it shows a schematic view of a fourth embodiment of the present invention, wherein a wire fastening band 50 is integrally formed by a soft rubber and includes a sleeve 501 after being formed. A circumferential surface of the sleeve 501 is also formed with a commissure 5011, and an outer circumferential surface of the sleeve 501 is extendedly formed with a wrapping member 502. As shown in the drawing again, above the commissure 5011 of the sleeve 501 are attached with a first Velcro tape 5012 (or a magnet) and a second Velcro tape 5014 (or a magnet), below the commissure 5011 is attached with a first corresponding Velcro tape 5013, and at a corresponding position on a plane of the wrapping member 502 is attached with a second corresponding Velcro tape 5021 (or a magnet). Upon implementing, the sleeve 501 is first sheathed on a wire 20 (such as an earphone wire or a power cable) with the commissure 5011, and then the first Velcro tape 5012 is affixed with the first corresponding Velcro tape 5013 to fix the wire fastening band 50 on the wire 20. Next, the wire 20 which is exposed out of the wire fastening band 50 is folded up, and emplaced flat on the plane of the wrapping member 502; then, the wrapping member 502 is rolled up to affix the second Velcro tape 5014 with the second corresponding Velcro tape 5021, thereby accomplishing the wire fastening operation quickly. In loosening the wire, on the other hand, it can be accomplished by only separating the second Velcro tape 5014 with the second corresponding Velcro tape 5021.

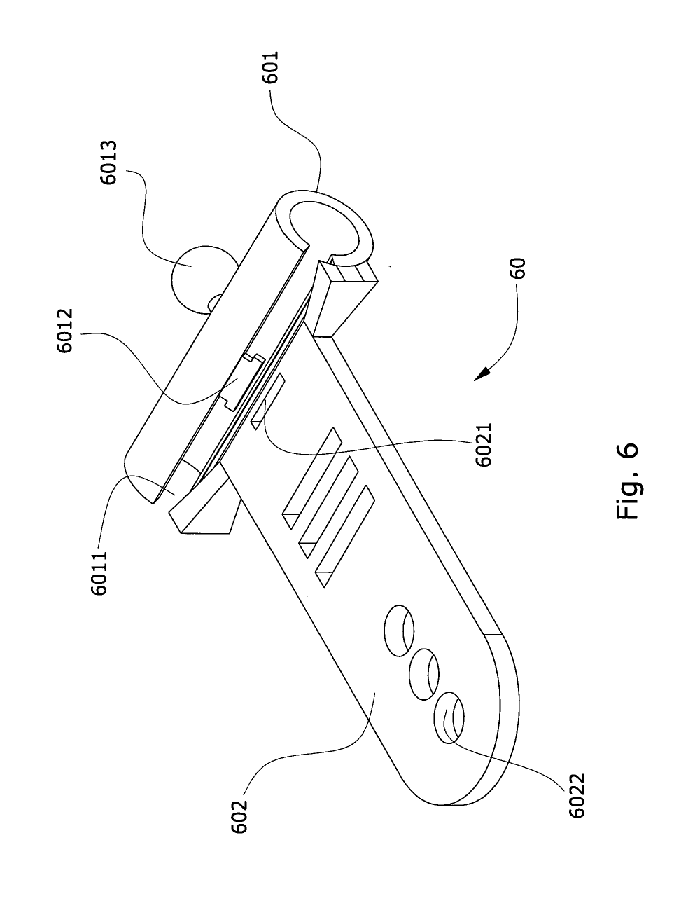

Referring to FIG. 6, it shows a schematic view of a fifth embodiment of the present invention, wherein a wire fastening band 60 is made by a soft material, such as formed by rubber extrusion, and the wire fastening band 60 is formed with a sleeve 601. An outer circumferential surface of the sleeve 601 is formed with a commissure 6011, and the sleeve 601 is sheathed on a wire by the formation of the commissure 6011. After sheathing, the wire fastening band 60 is hung on the wire normally, by a function of the sleeve 601. In addition, an end of the commissure 6011 of the sleeve 601 is formed with a first fastening member 6012, and an end of the outer circumferential surface is formed with a second fastening member 6013. As shown in the drawing, the outer circumferential surface of the sleeve 601 is extendedly formed with a plate or a strip of wrapping member 602, and on a plane close to a top of the wrapping member 602 is formed with a first corresponding fastening member 6021 which is formed as a through-hole; whereas, on a plane close to a bottom of the wrapping member 602 are formed with a plurality of second corresponding fastening members 6022 which are formed as through-holes. Upon implementing, after the commissure 6011 has been sheathed on the wire, the first fastening member 6012 is fastened with the first corresponding fastening member 6021, and then the collected wire is emplaced on the plane of the wrapping member 602. Next, the wrapping member 602 and the wire are wound upwards, allowing the second corresponding fastening member 6022 to be fastened with the second fastening member 6013, thereby enclosing the wire by the wrapping member 602. By the formation of the plurality of the second corresponding fastening members 6022, tightness of wire wrapping can be adjusted, and when the first fastening member 6012 is fastened with the first corresponding fastening member 6021, as well as the second fastening member 6013 is fastened with the second corresponding fastening member 6022, flexibility of the material itself is used to achieve effects of fastening and preventing the wire from being dropped out.

Accordingly, after implementing, an object of providing a wire fastening band which can be quickly and conveniently sheathed on a wire and can fix the wound wire without allowing the wire to be dropped out or intertwined can be achieved accurately.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A wire fastening band, which is used to sheath and fix a wire, and to wrap and fix the wound wire, comprising a sleeve, an outer circumferential surface of which is formed with a commissure, with a first fastening member, a second fastening member, and a first corresponding fastening member being formed close to the commissure, and the first fastening member being fastened with the first corresponding fastening member; a wrapping member which is formed extendedly from the outer circumferential surface of the sleeve; and a second corresponding fastening member, which is formed on a plane close to a bottom of the wrapping member and is fastened with the second fastening member.

2. The wire fastening band according to claim 1, wherein the first fastening member of the sleeve is formed as a protruded point.

3. The wire fastening band according to claim 1, wherein the second fastening member of the sleeve is formed as a protruded point.

4. The wire fastening band according to claim 1, wherein the first corresponding fastening member of the sleeve is formed as a through-hole.

5. The wire fastening band according to claim 1, wherein the second corresponding fastening member of the wrapping member is formed as a through-hole.

6. The wire fastening band according to claim 1, wherein the first fastening member and the first corresponding fastening member are Velcro tapes.

7. The wire fastening band according to claim 1, wherein the first fastening member and the first corresponding fastening member are magnets.

8. The wire fastening band according to claim 1, wherein the second fastening member and the second corresponding fastening member are Velcro tapes.

9. The wire fastening band according to claim 1, wherein the second fastening member and the second corresponding fastening member are magnets.

10. The wire fastening band according to claim 1, wherein an end of the commissure is formed with a first fastening member.

11. The wire fastening band according to claim 1, wherein a position close to a top of the wrapping member is formed with a first corresponding fastening member.

12. The wire fastening band according to claim 1, wherein the wrapping member is formed with more than one second corresponding fastening member.
